(19) United States
(12) Patent Application Publication
(10) Pub. No.: US 2012/0288958 A1
(43) Pub. Date: Nov. 15, 2012

(54) Carbon Laminated Materials for Sample Preparation

(76) Inventor: Jonathan Thompson, Center City, MN (US)

(21) Appl. No.: 13/522,600

(22) PCT Filed: Jan. 18, 2011
(86) PCT No.: PCT/US11/21537

§ 371 Date: Jul. 17, 2012

Related U.S. Application Data
(60) Provisional application No. 61/295,733, filed on Jan. 17, 2010.

(51) Int. Cl. B01J 20/20; G01N 1/34; B01J 20/32

(52) U.S. Cl. 436/178; 502/416; 502/415; 502/413

(57) ABSTRACT

A sample preparation material is described for supporting sample preparation procedures, such as solid phase extraction (SPE). The present sample preparation material is useful as a sorption media which is highly and selectively retentive for various analytes of interest. The sorption media is prepared by carbon deposition on target substrates, wherein the deposited carbon substantially covers the substrate. In some embodiments, the substrate may be porous particles, which retain their porosity subsequent to carbon deposition.

### FIELD OF THE INVENTION

The present invention provides carbon laminated porous materials which are useful as a sample preparation medium and solid phase extraction support material. The invention also provides a method for manufacturing the chromatographic support material, by laminating carbon on porous materials with a chemical vapor deposition (CVD) process carried out in a fluidized bed.

### BACKGROUND OF THE INVENTION

Solid phase extraction (SPE) is a common sample preparation technique used for selectively isolating and pre-concentrating target analytes from a sample matrix. Its use is preliminary to determinative techniques such as GC, HPLC, or ICP-MS. It is an indispensible tool in trace environmental analysis, forensic analysis and analysis of impurities in pharmaceuticals. SPE is distinct from high pressure liquid chromatography (HPLC) as SPE typically operates at low pressures (<20 psi) and uses large (20-100 μm) irregularly shaped particles. SPE sorbents are typically loosely packed or placed in single-use polymeric disposable tubular cartridges, centrifuge tubes, disks, or 96-well plates. Conversely, HPLC particles are stringently monodisperse and are mechanically strong enough to withstand packing pressures far exceeding 5000 psi. SPE packing materials have chemistries that are similar to those employed in HPLC and can range from garden variety hydrophobic bonded phases on silica to boutique customizable molecularly imprinted polymers. The sample preparation process typically requires four steps: conditioning the sorbent, adding the sample, washing away impurities, and eluting the target analyte(s) in as small a volume as possible with a strong solvent. In this way, the analyte can be partially isolated and greatly concentrated prior to analysis.

A particular mode of chromatography is commonly referred to in the art as flash chromatography. Sorption media appropriate for flash chromatography typically involve particles have an average particle size distribution that is smaller (30-60 μm) than sorption particles for SPE (60-250 μm), but much larger than HPLC particles (<10 μm). Preparative chromatography sorption media is distinct from flash, SPE, and HPLC particles in that they are typically spherical, porous, and are preferably more monodisperse compared to the sorption particles commonly used in flash chromatography and SPE. Their particle size can range from 5-20 μm but are most commonly 10 or 20 μm monodisperse particles.

An important property of SPE sorption media, particularly for trace analysis, is that it is desirably highly and selectively retentive for the analyte of interest so that a large volume of sample can be passed through the device to achieve a high degree of pre-concentration. The high retention is desired to avoid loss of sample by pre-elution. Graphitized carbon sorbents have been used for SPE due to their ability to retain and then release very polar analytes that would not be significantly retained on traditional C18-modified silica bonded phases. The unique selectivity originates from the fact that pure graphite is a crystalline material made up of sheets containing large numbers of hexagonally arranged sp2 hybridized carbon atoms linked by conjugated pi-bonds. These highly hydrophobic but exceptionally polarizable sheets of carbon have a high affinity for analytes that are also highly polarizable, highly polar or can accept a hydrogen bond. For example, polar nitrobenzene (π*dipolarity ˜1.11) is much more retained on carbon than is benzene (π*˜0.52). This is in contrast to other conventional alkyl bonded phases that do not easily retain polarizable molecules. There are many examples of applications that take advantage of the selectivity property, including concentrating water soluble micropollutants from water, drug metabolites, and pesticides.

Silica bonded sorption media typically contains trace amounts of unreacted silanols that retain or repel analytes depending on the pH of the eluent. Since the carbon sorption media described above does not have charged moiety, it can retain anionic species (e.g. NO3-, ClO4-) solely on their hydrophobic or polarizability properties. Applications include benzene and naphthalene sulfonates, acidic pesticides, and highly hydrophilic metabolites in blood and urine. Carbon also has advantages over synthetic polymeric supports that can shrink and swell as the solvent, pH, and ionic strength are changed. Other applications specific to carbon include selectivity for planar molecules. One example application for carbon sorption media is the trace extraction of coplanar polychlorinated biphenyls (PCBs), dibenzo-p-dioxins and dibenzofurans from other PCB congeners.

Despite the fact that SPE carbon based sorbents are widely used in these important analyses, it is clear that commercially available materials have significant drawbacks. These shortcomings include the lack of appropriately sized pore structure that results in a low surface area and thus low capacity. Conventional carbon-based sorbents are typically not monodisperse, yielding sorbent beds with many channels, and the particles are very fragile. Fragility represents one of the most significant shortcomings of typical carbon SPE sorbents. As is shown in FIG. 1, conventional carbon sorption particles typically readily decompose into fines (dp<1 μm) under small stresses that would normally be encountered in manufacturing. Slide A shows particles before a microscope slide cover is placed over the carbon particles and slide B shows the crushed carbon particles that are produced by slight pressure (<5 psi) placed on the microscope slide. Beyond the obvious occupational health problems associated with the generation of fine pyrolitic carbon particles that tend to disperse in the air, fines remaining in the packed bed elute through the frit and contaminate the eluted chromatography sample with solids. These solids must be removed by a filtration step prior to injecting onto an expensive HPLC column in order to prevent plugging of the column This filtration step is undesirable because it consumes the sample and the filter itself can add additional impurities such as perfluoro-ocanoic acid (PFOA). As an additional consequence, the presence of fines compromises analyte recovery and the reproducibly of recovery from cartridge-to-cartridge.

Current HPLC/MS methods for the determination of PFOA suffer from a significant positive interference from PFOA that is present in HPLC solvents (chiefly methanol) and HPLC degasser tubing and pump seals. This system sourced PFOA interferes with the analysis of PFOA in the sample. Carbon is an ideal adsorbent for PFOA because these phases are highly retentive for polar molecules similar to PFOA. Guiochon's eluotropic series puts methanol very low on the solvent strength scale for carbon substrates. Therefore, carbon adsorbents can retain polar and hydrophobic analytes even in 100% methanol where C18 bonded phases could not. Methanol clean up using a carbon cartridge can certainly be completed off-line. However, in order to eliminate PFOA from the HPLC system, a disposable carbon adsorbent cartridge would need to be installed after the high pressure pump. This is not possible for current carbon-based SPE materials due to their inherent mechanical instability described above.

A SPE cartridge typically consists of an elongated polypropylene tube partially filled with adsorbent material(s) that may (or may not) be encased between two porous polymeric fits. SPE cartridges may be either slurry packed or dry packed. The slurry fluid can be any fluid that will disperse the particles. The packing procedure for a traditional SPE tube device includes a first step of pressing the frit into the cartridge. Subsequently, the sorbent particles are weighed on a balance and placed in the cartridge. Due to the electrostatic attraction of carbon particles for the tube wall, the particles stick to the side of the cartridge. When the upper frit is installed, the shear stress between the frit and the wall easily breaks the particles, leaving a residue of carbon on the wall and fines in the sorbent bed. It is critical that the upper frit does not compress the carbon bed so that the particles do not break. Thus, in a commercial cartridge, the frit does not substantially compress the bed, leaving it loose. Consequently, the bed settles as the cartridge is conditioned with fluid leading to channeling and variable cartridge-to-cartridge flow and recovery characteristics.

Compared to HPLC sorption particles, the physical and chemical requirements for SPE sorption particles are much less demanding. However, it is clear that at a minimum, the particles should be stable enough to endure the rigors of packing. The particles should also have appropriate pore sizes (60-150 Å), have a high surface area (>100 m2/g), and may preferably have a chemically homogeneous surface. Other characteristics include: 1) The support (particles) should be inexpensive so that it can be disposed of after a single use; 2) The support should allow facile and complete elution of the analyte to give high absolute recoveries for the selected analyte, 3) The packed bed permeability should be high to improve speed of use, 4) The support or column should not have extractable impurities from the manufacturing process (e.g. plasticizers) that interfere with determination of the desired analytes; and 5) The sorbent surface and particle size distribution should be consistent from batch to batch so that recovery will be reproducible.

Traditional carbon-based supports available for use in low pressure solid phase extraction applications include: graphitized carbon black (GCB), pyrocarbon reinforced GCB, and porous graphitic carbon (PGC). Unreinforced GCB materials, however, are generally too fragile to use in SPE applications. Pyrocarbon reinforced GCB is currently the most widely used carbon based SPE material. However, the reinforcement manufacturing process does not uniformly reinforce the particles. Thus, a portion of the particles still commonly break during packing.

K. Unger et al. (U.S. Pat. No. 4,225,463) describe porous carbon support materials based on activated carbons and/or cokes. The materials are prepared by treating hard activated carbon or coke particles with solvents, and then heating them at 2400-3000° C. under an inert gas atmosphere. The resulting support materials are described as having a carbon content of at least 99 percent, a specific surface area of about 1-5 m2 per gram, and a particle size of about 5-50 μm. The resulting surface area and pore size are not generally reproducible.

U.S. Pat. Nos. 5,254,262, and 5,108,597 describe the cladding of carbon on metal oxide particles such as zirconia. The inventors emphasize and teach how to achieve monodispersity, extreme pH stability, and high efficiency. None of these characteristics are essential for SPE. Using low pressure, high temperature vapor deposition a carbon separation material was produced by pyrolizing a variety of saturated and unsaturated hydrocarbons on zirconia at 700° C. in a flow-through horizontal rotary reactor. The residual exposed hard Lewis acid sites on the zirconia substrate causes irreversible adsorption of many lewis bases. Thus, the adoption of this phase has been limited.

U.S. Pat. Nos. 5,271,833, 5,182,016 describe the coating and cross-linking of a monomer on the surface of the carbon laminated zirconia. These patents describe a process to make the carbon particles similar to that described in U.S. Pat. Nos. 5,254,262 and 5,108,597.

U.S. Pat. No. 5,431,821 describes coating an oligomeric acetylene based polymer on the surface of porous silica with subsequent carbonization in a flow through batch reactor. The carbon source is deposited on the surface by evaporation and is subsequently carbonized. The make-up gas does not carry a carbon source. Although the patent asserts the material as useful for SPE, this material suffers from blocked pores, which makes the sorbent material not useful for SPE.

Leboda et al. (Chromatographia, 13, 703 (1980); Chromatographia, 14, 524 (1981); Chromatographia, 13, 549 (1980)) describe chemical vapor deposited (CVD) methylene chloride on porous silica surfaces at 300-500° C. with subsequent deposition of a variety of aromatic alcohols (n-octanol) as a post treatment to complete the surface coverage. The resulting HPLC material showed significant amounts of accessible silanols on the surface. These residual silanol sites are known for inducing low recovery of cationic compounds such as organic bases. Many of the key analytes for which carbon phases are used, e.g. triazine herbicides, are amines. Leboda attempted to solve this problem by silanizing the surface. Furthermore, Leboda used two methods to make the particles. First, Leboda et al. describe the two-hour pyrolysis of dichloromethane (CH2Cl2) on partially dehydroxylated silica gel (particle size range 0.15-0.30 mm) at 500° C. and atmospheric pressure in an autoclave. This method would not likely be desired for the particles of the present invention because the absence of mixing prevents uniform coating of large batches (>500 g/batch) required to be economically viable. Additionally, Leboda, Chromatographia, 12, No. 4, 207-211 (1979) describe the catalytic decomposition of alcohol onto the surface of Si02 in an autoclave, at a pressure of 25 atmospheres and a temperature of 350° C. for 6 hours. The resulting material possesses a surface having from “a few to several dozen percent carbon on the surface.” The problem with this technique is that the particles are not mixed as the reaction occurs. Leboda has also described a low pressure (<50 mm Hg) rotary reactor for the production of carbon coated particles to improve the mixing.

PGC is prepared by filling the pores of a silica gel with a polymer comprising carbon, thermolyzing the polymer to produce a silica/carbon composite, dissolving out the silica to produce a porous carbon, and subjecting the porous carbon to graphitizing conditions.

For example, U.S. Pat. No. 4,203,268 describes a method for producing a porous carbon material suitable for chromatography or use as a catalyst support, which involves depositing carbon in the pores of a porous inorganic template material such as silica gel, porous glass, alumina or other porous refractory oxides having a surface area of at least 1 m2/g, and thereafter removing the template material. The resulting carbon is not a true graphite, but it does have a structure similar to two dimensional graphite making it chromatographically essentially indistinguishable from carbon that has been graphitized. Even though the material is mechanically stable enough to be used as an SPE adsorbent, the material suffers from an expensive manufacturing process that is not amenable to use in a disposable, single-use SPE cartridge.

O. Chiantore et al., Analytical Chemistry, 60, 638-642 (1988), disclose carbon sorbents which were prepared by pyrolysis of either phenol formaldehyde resin or saccharose on spheroidal silica gels coated with these materials. The pyrolysis is performed at 600° C. for one hour in an inert atmosphere, and the silica was subsequently removed by boiling the material in an excess of a 10% NaOH solution for 30 minutes.

Chiantore et al. conclude that, at the temperatures employed, the carbonaceous polymer network that was formed still maintained the chemical features of the starting material (page 641, column 2). To obtain carbons where polar functional groups have been completely eliminated, the authors conclude that high temperatures (greater than 800° C.) treatments under inert atmosphere are necessary.

In addition to materials which comprise a carbon matrix or core, chromatographic support materials are known which have a carbon coating on a substrate of silica. For example, N. K. Bebris et al., Chromatographia, 11, 206-211 (1978) describe the one-hour pyrolysis of benzene at 850° C. onto a substrate of Silochrom C-120, a macroporous silica (Si02) which contains particles of irregular form with an average size of 80 μm. Benzene pyrolysis was also carried out at 750° C. onto a substrate of Spherisorb S20W, a silica gel which contains spherical particles of diameter 20 μm.

P. Carrott et al., Colloids and Surfaces, 12, 9-15 (1986) cracked furfuraldehyde vapor on precipitated silica at a temperature of 500° C. for various times, to achieve carbon loadings of 0.5, 8.6 and 16 percent. Carrott et al. conclude that the external surface of the resulting carbon-coated silica was hydrophobic, while the internal surface was hydrophilic, indicating that the internal surfaces were not well coated.

H. Colin et al., J. Chromatography, 149, 169-197 (1978) compare non-polar chemically-bonded phases (CBP), pyrocarbon-modified silica gel (PMS) and pyrocarbon-modified carbon black (PMCB) as packings for reversed phase HPLC.

Catalyst supports have also been prepared by deposition of carbon on alumina. For example, S. Butterworth et al., Applied Catalysis, 16, 375-388 (1985) describe a y-Al203 catalyst support having a coating of carbon deposited by vapor-phase pyrolysis of propylene. The pure phase y-Al203 substrate was ground to 12×37 mesh, had a bimodal pore size distribution based around mean diameters of 110 nm, and a surface area of 130 m2/g. When the vapor phase pyrolysis was performed from a flowing gas mixture of argon and propylene at 673 K, Butterworth et al. describe that the pure phase y-Al203 was completely covered at a carbon loading of 7 wt-%.

Certain metal oxides have been coated with carbon for use as nuclear reactor fuels. For example, P. Haas, Chemical Engineering Progress, 44-52 (April 1989) describes that small spheres of oxides of U, Th and Pu were required for high-temperature, gas-cooled nuclear reactor fuels. These fuels were coated with pyrolytic carbon or other ceramics to serve as “pressure vessels” which would contain fission products (page 44, column 2). FIG. 2, at page 49, shows dense Th02 spheres with pyrolytic carbon coatings.

Chemical vapor deposition (CVD) is a vapor phase process wherein a solid material is formed on a substrate by the thermal dissociation or the chemical reaction of one or more gas species. The deposited solid material can be a metal, semiconductor, alloy, or refractory compound.

The use of CVD processes to produce carbon coatings has been extensively studied. Such processes are used, for example, to carbon coat nuclear materials or to infiltrate porous bodies so as to produce lightweight structural materials. This topic is discussed in more detail in 9 The Chemistry and Physics of Carbon, 173-263 (P. Walker et al., eds. 1973), the disclosure of which is incorporated by reference herein.

### SUMMARY OF THE INVENTION

The present invention provides a composite support material which is useful as a sorbent in analytical or preparative scale solid phase extraction. The material is preferably produced in large quantities by depositing carbon from the gas phase on substrate particles in a fluidized bed or a high pressure horizontal rotary kiln The material comprises carbon-laminated particles of, for example, aluminum, iron or silica oxide. In order to facilitate packing of polymeric SPE cartridges, it is preferred that each individual unit be of sufficient mechanical strength to withstand the packing and subsequent elution process. It is also preferred that the carbon laminate material be treated after manufacture to mask the residual uncovered substrate material.

As used herein, the phrase “carbon laminated” means that an outer layer, sheath, coating, or cladding of pyrolytic carbon is bonded or otherwise attached to the underlying substrate. As used herein, “pyrolytic carbon” is intended to refer to carbon formed by the carbonization of a suitable carbon source. The term “carbon laminate” refers to the carbon that is bonded or otherwise attached to the underlying substrate.

The substrate is preferably a porous silica, alumina, or silicon carbide with a particle diameter greater than 10 μm and less than 500 μm. However, any substrate that can be coated using the disclosed process may be used. In some embodiments, the substrate cross-sectional dimension may be 60-200 μm. Although the substrate preferred shape is a particle, the present invention also anticipates carbon laminated porous and nonporous rods, whiskers, membranes, fabrics, wools, or macroporous frits. The particle can be spherical or irregular. Irregular particles may be preferred in some cases because they are much less expensive than spherical particles.

The substrate materials have an appropriate surface area, which may be greater than 10 m2/g. In some embodiments, the surface area is between 100-300 m2/g. The pore size of porous base substrate material may be 10-5000 angstroms, and, in some embodiments may be between 60-300 angstroms. However, it is anticipated that nonporous particles may also be used for SPE support purposes. The carbon laminate is preferably pyrolitic and nonporous although it is anticipated that the carbon layer itself can be treated to render it porous.

As used herein, the term “pores” (or “porosity”) refers to “open pores” only. Pores may be defined as open voids with a minimum mean diameter of at least 10 angstroms and a minimum mean depth that is greater than the respective minimum mean diameter. A porous material is defined as having pores, i.e. cavities, channels, or interstices, which are deeper than they are wide. The pores defining a porous material are permanent and arranged.

By “surface of the particle”, it is meant the exterior surface as well as the surface of the open pores. It is intended that the carbon laminate cover substantially all of the surface of the porous substrate material, thus defined. As used herein, “substantially covering” or “substantially all” means that at least about 50% of the total surface area of the porous substrate material is covered by the carbon laminate. The carbon laminate makes up about 3-40% of the composite material as determined by elemental analysis and in some embodiments is between 10-30% of the composite material. In one aspect, the pores are preferably not filled with pyrocarbon. Thus, the amount of deposited carbon that will provide retention and coverage but will not fill the pores will depend on the pore size of the substrate, and permits fluid transport into and out from the open voids of the coated pores.

In some embodiments, the thickness of the carbon laminate over the surface of the porous substrate ranges from the diameter of a single carbon atom, to about 50 angstroms. Thus, the carbon laminate may not appreciably decrease the diameter of the pores of the substrate, and permits fluid transport into and out from the open voids of the coated pores.

The surface of the substrate particle that is not covered by the lamination process may be treated with a masking reagent to improve the chemical homogeneity of the surface. Unreacted residual silanol species on the surface of the particle may be silanized with an appropriate silanization reagent. Unreacted residual Lewis acid species on the surfaces of Lewis acids such as alumina may be reacted with an appropriate Lewis base to render inactive the Lewis acidity of the surface.

The present invention further includes a method of preparing carbon laminated materials comprising: 1. providing inorganic materials having a surface area greater than about 10 m2/g; exposing the inorganic particles to a carbon containing gas at pressures greater than 760 mm Hg; and thermostatting the carbon source at a temperature greater than or equal to room temperature; and heating the inorganic particles and carbon containing gas for a time sufficient to deposit a substantially uniform layer of pyrolytic carbon on the particles. In some embodiments, the present invention utilizes a vertical fluidized bed to suspend the materials and deposit the carbon from the vapor phase on the porous particles. The temperature of the process may be greater than 400° C. and, in some embodiments, is between 600-800° C. The carbon source may be, for example, a saturated or unsaturated hydrocarbon or halocarbon. Alternatively, carbon monoxide may be used as the carbon source. Hexane may be used as a carbon source for alumina substrate, and methylene chloride may be used as a carbon source for silica substrates. The present method may also optionally include an additional step of exposing the carbon laminated particles to a gaseous reducing mixture comprising hydrogen so as to cause the reduction of polar functional groups on the surface of the particles. In this manner, a more homogeneous surface chemistry can be achieved.

### BRIEF DESCRIPTION OF THE DRAWINGS

FIG. 1. shows fragile carbon SPE supports of the prior art.

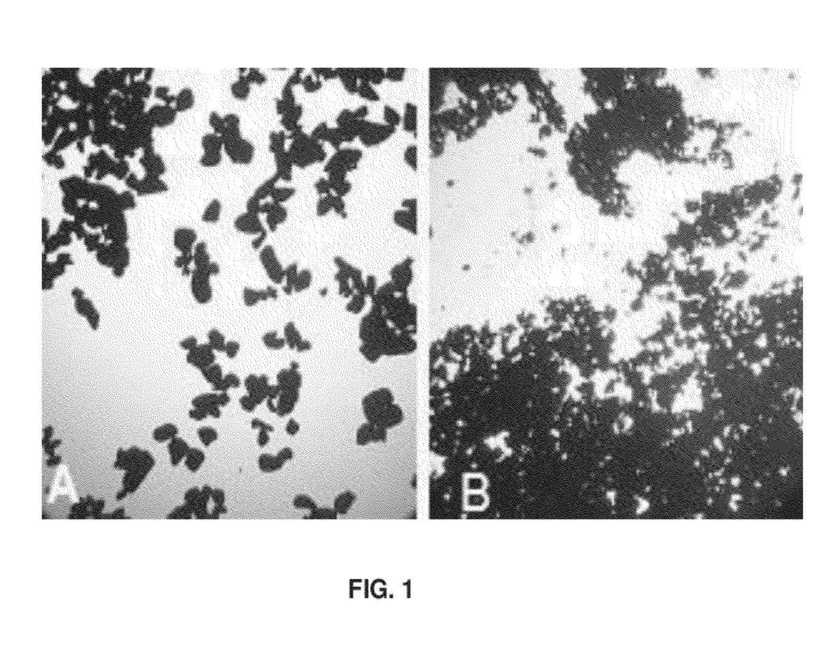

FIG. 2. shows carbon laminate alumina of the present invention that has been treated to remove unreacted residual lewis acid sites.

FIG. 3. shows carbon laminate silica of the present invention that has been treated to remove unreacted residual silanol sites.

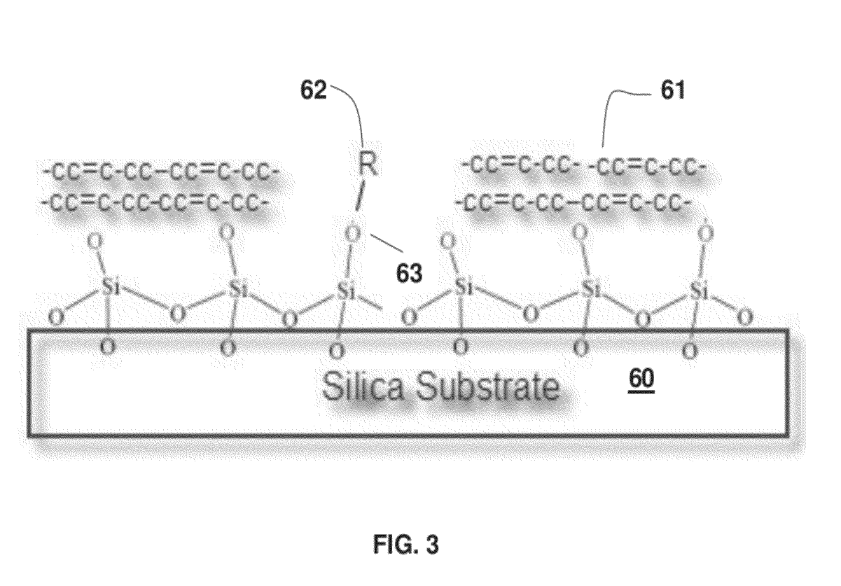

FIG. 4. shows a chemical reaction chamber of the present invention.

FIG. 5. shows a chemical reaction chamber of the present invention.

FIG. 6. shows a chemical reaction chamber of the present invention.

FIG. 7. shows the linearity of recovery of bromacil on carbon laminated alumina.

FIG. 8. shows the linearity of recovery of bromacil on carbon laminated silica.

FIG. 9. shows an example of an eluent cleaning device of the present invention.

FIG. 10. shows a carbon composite iron particle.

FIG. 11 shows a method for utilizing the carbon composite particles in dispersive solid phase extraction.

### DETAILED DESCRIPTION OF THE PREFERRED EMBODIMENTS

The present material comprises a particle, comprising a core, base or substrate, and a laminate of carbon over the core. For the purposes of the present invention, the terms core, base, and substrate interchangeably refer to the material to which carbon is laminated to form the composite support material. The core may be porous or non-porous. In some embodiments, the core is a porous alumina or silica.

Because an intended use of the present support material is in solid phase extraction applications, the individual units of the support material may be irregular in shape, in order to keep the cost at a minimum. The present invention is also intended to encompass spherical particles, which are useful for improving the flow characteristics of an SPE column if the cost is not prohibitive. Although the substrate preferred shape is a particle, the present invention also anticipates that substrates of various shapes can also be utilized for SPE purposes. Such shapes include porous and nonporous rods, whiskers, membranes, fabrics, wools, or macroporous fits.

With reference to the materials of the present invention embodied in particles, the diameter of the substrate alumina or silica particles may vary within ranges appropriate for the desired use of the particles. Generally in solid phase extraction applications, particles ranging from 10-300 μm in diameter are preferred, and more preferably, about 60-200 μm in diameter. The particles are preferably substantially free from fines that have particle diameters of less than 1 μm.

The criteria for utility of a particular material as the substrate for the present carbon laminated particles are that the substrate material possess a high total surface area and thus good sorption capacity, and that such surface area is not excessively reduced during the carbon laminating process and any other subsequent laminating procedure included within the scope of the present invention. Therefore, example surface areas for the substrate alumina or silica particles may be larger than 10 m2/g and may be in the range from 10-500 m2/g, and more preferably about 100-300 m2/g.

The present carbon laminate particles may be prepared by a high pressure chemical vapor deposition (CVD) method utilizing a fluidized bed or a rotary kiln, as discussed below, which method is also included within the scope of the present invention. Therefore, the pore diameter of the substrate material must be sufficiently large to permit ready diffusion of hydrocarbon vapor into the pores of the substrate particle during CVD. Thus, pore sizes for the substrate particles may range from about 10-5000 angstroms, and, in some embodiments, may be between 60-300 angstroms

The present particles are laminated or coated with pyrolitic carbon. While any method of applying pyrolitic carbon to a porous substrate can be used in the preparation of the present carbon-laminated particles, it is preferable to apply the carbon laminate in a manner which results in substantial carbon coverage of the porous surface. One particular method, detailed below, employs a high pressure chemical vapor deposition technique to substantially laminate carbon on a porous inorganic oxide particle. For example, by utilizing the present method, a carbon laminate can be applied to alumina which covers at least 75% of the total exposed surface of the particle. The carbon laminate is preferably 3-40% of the composite material and is more preferably 15-30% of the composite material, as determined by elemental analysis.

The laminated composite materials are preferably washed in a series of strong solvents to remove reaction and carbonization byproducts that may be adsorbed to the substrate surface after the reaction. The composite materials, once washed, will show little orno volatile and non-volatile extractables. To accomplish this, the particles may be sonicated in a low-pressure environment to remove the air from the substrate pores, and may also be subjected to soxhlet extraction in a series of solvents. The solvents may include hexanes, toluene, tetrahydrofuran, acetone, and/or methylene chloride.

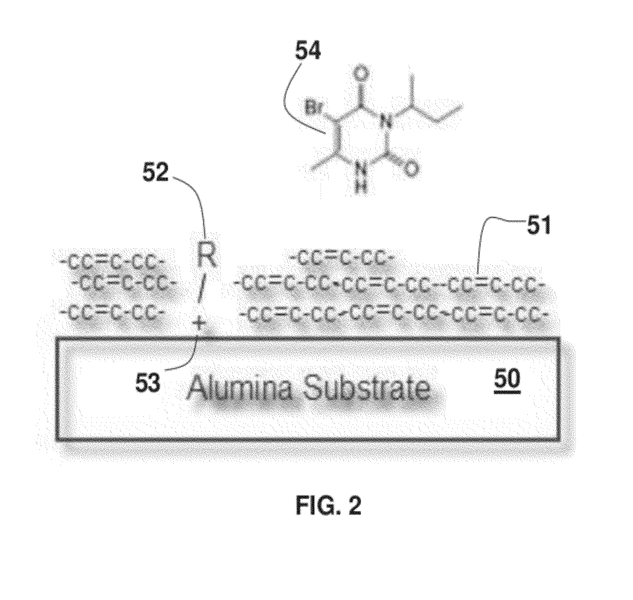

The present carbon laminated materials may also be treated with reagents that mask any exposed residual substrate surface that has not been covered by the CVD lamination method. FIG. 2, for example, shows a carbon laminate 51 on an alumina surface 50 with an uncovered Lewis acid site 53 that has been reacted with a Lewis base 52 to cover the Lewis acid site and to make it inaccessible to an analyte 54. This is preferably accomplished by exposing the residual substrate surface 50 to a strong Lewis base 52 and subsequently heating for a sufficient amount of time to allow the Lewis base 52 to react with the Lewis acid 53 to permanently adsorb the Lewis base 52 to the substrate surface 50. The Lewis base 52 may be phosphoric acid. However, any Lewis base 52 that has sufficient affinity for the Lewis acid substrate is suitable. Other embodiments for Lewis base 52 include a phosphoric acid that includes ligands other than oxygen such as a phenyl, vinyl or sulfur group. The vinyl group can be subsequently reacted and cross-linked to the carbon laminate 51 or to adjacent reactive groups and optionally recarbonized.

Likewise, for carbon laminated 61 silica substrate 60, unreacted residual silanols 62 may be silanized with an appropriate silanization reagent 63. The silane reagent may be of the general formula RSiO3 where R is any ligand commercially available. R can also be cross-linkable ligand that is subsequently reacted and cross-linked to the carbon laminate 61 or to the adjacent reactive group. This material can be optionally recarbonized.

It is anticipated that the surface coverage of the substrate particle can be controlled to obtain particles with any desired amount of coverage by varying the processing conditions. This can be advantageous since the remaining uncovered portion of the substrate surface can be derivatized with distinct chemistries to produce SPE support materials with dual selectivity. For instance, the treatment of the surface of alumina substrate particles with phosphoric acid places a negative charge on the surface of the particle. Such charge can be used to selectively catch positively charged bases, for example. Alternatively, the carbon source, such as acetonitrile, can incorporate nitrogen into the carbon layer. Use of acetonitrile as a carbon source produces a material with dual selectivity characteristics, and is useful in sorbing organic acids.

The present invention also encompasses a method for forming a solid phase extraction support material utilizing chemical vapor deposition at high pressure. Either porous or essentially non-porous inorganic oxide particles can be employed as the substrate material. Advantageously, both the interior and the exterior surfaces and the surfaces of any open pores of the inorganic oxide substrates treated in accordance with the present method can be substantially covered with a laminate of carbon. By “high pressure,” it is meant that the pressure of the vaporized carbon source in the deposition chamber is more than about 100 Ton, and may be greater than about 700 Torr.

The preferred temperature to be maintained in the reaction chamber during deposition of carbon according to the present method ranges from about 500-1500° C., and may be between about 600-1000° C. The deposition time of the reaction may be between about 1 minute-10 hours, but, in some embodiments, more preferably is between 5-6 hrs, which is considerably less than in conventional CVG processes, primarily due to the unique pressure and temperature reaction conditions explored in the present invention.

The temperature of the carbon source may also be maintained at a temperature greater than 0° C. Carbon deposition may be accelerated by maintaining the carbon source at or greater than room temperature, and such acceleration may provide an economically viable method of large-scale carbon deposition in relatively short batch reaction times. In one embodiment, the carbon source may be maintained (thermostatted) at room temperature. In another embodiment, the carbon source temperature is elevated to, for example, up to 35° C. In this manner, carbon source temperature may be adjusted and thermostatted to provide a desired carbon deposition amount within a reaction time of between about 6-12 hours. The reaction conditions, including carbon source temperature, should be closely controlled to assure high quality carbon deposition. For example, if carbon deposition is too rapid, substrate pores may plug with overdosing of carbon. On the other hand, if the rate of carbon deposition is too slow, the process becomes economically unviable to produce large quantities in reasonable reaction times.

In another aspect, carbon concentration introduced into the reactor may be adjusted by diluting a pure carbon source, such as propane, with a dilution gas, such as nitrogen. Dilution allows the use of pure carbon sources without supersaturating the target substrate.

Although any material meeting the surface area and porosity criteria may be employed as a substrate material in the present method, preferred materials include inorganic oxides, and may particularly include those inorganic oxides commonly employed in sorbent applications, e.g., iron oxides, SiO2, TiO2, Al2O3, MgO, and ZrO2. The invention also anticipates that ceramic particles such as silicon carbide, silicon nitride, titanium carbide, titanium nitride, ceria, and glass whiskers may also be used as the substrate material. Suitable porous SiO2 solid phase extraction grade materials are commercially available. Suitable Al2O3 spherules are commercially available under the trade name Spherisorb Alumina from Phase Sep, Inc., Hauppauge, N.Y. Suitable TiO2 spherules can be prepared as described in U.S. Pat. No. 4,138,336. Suitable iron oxide particles may be obtained commercially. Compounds or mixtures of more than one material may also be employed in the present method as the substrate. Inorganic whiskers can also be used as the substrate in SPE applications. Inorganic whiskers employed in the present invention are preferably 1-15 mm in length and 1-20 μm in diameter.

Any carbon source which can be vaporized and which carbonizes on the surface of the substrate under the temperature and pressure reaction conditions of the present method may be employed to deposit a carbon laminate via CVD. Useful carbon sources include hydrocarbons such as hetrocarbons such as acetonitrile, pyridine, and the like, aromatic hydrocarbons, e.g., benzene, toluene, xylene, and the like; aliphatic hydrocarbons, e.g., heptane, cyclohexane, substituted cyclohexane butane, propane, methane, natural gas, and the like; unsaturated hydrocarbons; branched hydrocarbons (both saturated and unsaturated), e.g., isooctane; ethers; ketones; aldehydes; alcohols such as heptanol, butanol, propanol, and the like; chlorinated hydrocarbons, e.g., methylene chloride, chloroform, trichloroethylene, and the like; and mixtures thereof. Another useful carbon source may be a gaseous mixture comprising hydrogen and carbon monoxide, as described by P. Winslow and A. T. Bell, J. Catalysis, 86, 158-172 (1984), the disclosure of which is incorporated by reference herein

The carbon source may be either a liquid or a vapor at room temperature and atmospheric pressure although it is employed in the CVD process in vapor form. If the carbon source is a liquid with low volatility at room temperature, it may be heated to produce sufficient vapor for the deposition process.

In general, the choice of the optimum deposition temperature, pressure and time reaction conditions are dependent on the carbon source employed and the nature of the substrate. For example, higher hydrocarbon vapor pressures, higher deposition temperatures and longer deposition times generally lead to increased amounts of carbon being deposited. Higher deposition temperatures and higher total pressures, however, also result in a greater tendency for deposition to be localized on or near to the peripheral surface of the substrate particles. If such increased deposition on the exterior substrate surface restricts access of the hydrocarbon vapor to the surfaces of the pores of the particle, these internal surfaces may be poorly coated, therefore impairing the chromatographic performance of the coated substrate. Furthermore, restricted access to the pores may also reduce the utility of the particle. Thus, it is preferable to optimize deposition conditions so than the carbon laminate substantially and evenly covers both the external substrate surface and the surfaces of the pores in the substrate, and does not restrict subsequent access of hydrocarbon to the surface of the pores. In some embodiments, optimal deposition characteristics may be achieved through lower deposition temperatures, e.g., 500-1000° C. and longer deposition time, e.g. up to 6 hrs, with very low concentrations of carbon in the vapor, low concentrations of vapor feed at pressures greater than atmospheric pressure. Therefore, optimum conditions may require a compromise between degree of surface coating and length of deposition time. Advantageously, the present method results in substantially complete surface coverage of the substrate SPE materials, i.e., at least about 50%, preferably at least about 90%, and more preferably at least about 95% of the substrate surface covered.

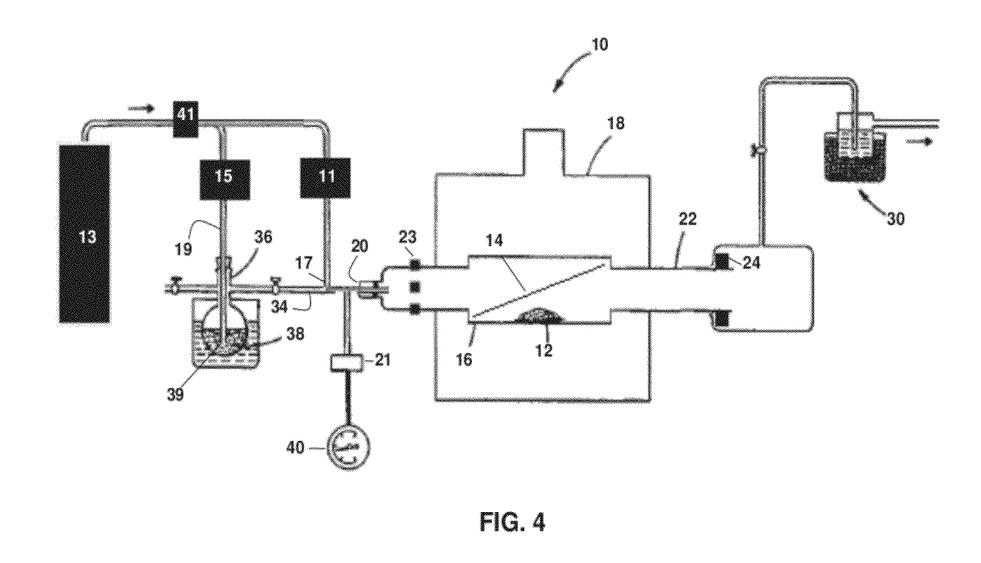

An example chemical vapor deposition apparatus for the production of small batches, for example of less than 1 kg, is shown schematically in FIG. 4 by reference numeral 10. A sample 12 of uncoated substrate material is centrally positioned within a tubular reaction chamber 16 that has a plurality of inwardly protruding diagonal longitudinal mixing splines 14. Tubular reaction chamber 16 may be situated substantially cocentrically within tubular furnace 18, which has a first end 20 and a second end 22 connected to the reaction chamber 16 with o-ring joint end fittings 24. Tubular reaction chamber 16 also has disposed in close proximity to the first end 20 a rotary engagement device that rotates the reaction chamber 16 by 90 to 180° about a substantially horizontally-oriented longitudinal axis to mix the sample substrate particles 12 with the longitudinal mixing splines 14. The rotation sequentially advances and recedes by to a selected extent, such as 180°. The rate of successive advances can be controlled to control the amount of mixing in the reactor. Tubular furnace 18 also includes means for maintaining the elevated reaction temperature, e.g., 500-1500° C., within the furnace, for the chemical vapor deposition of the present invention. The pressure within tubular reaction chamber 16 is maintained during the reaction at a pressure which typically exceeds atmospheric pressure. The pressure may be measured by pressure sensor 21 and indicated by pressure gauge 40, or by any other suitable means.

Reaction Chamber 16, which may be quartz, is connected to tubing 34, which is in turn connected to a flask 36 containing a carbon source 38. The temperature of carbon source 38 may be maintained by a temperature control bath in which flask 36 may be immersed, or by other suitable means known in the art. It is preferred that the carbon source 38 and the temperature control bath are both stirred to maintain a constant temperature. The temperature control bath may be any material which is effective in transferring thermal energy to or from carbon source 38. In some embodiments, temperature control bath may be a liquid solid mixture such as ice and water or a dry ice and acetone. In other embodiments, however, carbon source 38 need not be thermostatted to a reduced temperature, and may instead be thermostatted or non-thermostatted at temperatures equal to or greater than room temperature.

An inert gas from a pressurized reservoir 13 flows through an oxygen scrubber 41 to feed flow controllers 15 and 11 to deliver both carbon and make up gas to the reaction chamber 16. To produce a carbon vapor, the inert gas from reservoir 13 flows through flow controller 15 at a flow rate empirically determined. Gas reservoir 13 may be thermostatted with an appropriate electrical heating mantle or water bath at greater than 0° C. In one embodiment, gas within reservoir 13 may be thermostatted at room temperature or greater. The gas exiting the flow controller flows through tube 19 and into a diffuser 39, thus causing inert gas to become saturated with carbon vapor. The carbon vapor can optionally be diluted with makeup gas from pressurized gas reservoir 13 flowing through controller 11 by mixing at tee 17. Carbon source vapor is carried through the tubing 34 and into the reaction chamber 16, where it decomposes upon contact with sample 12 maintained at the reaction temperature, e.g., 500-1500° C., within the reaction chamber. Thus, a thin laminate of carbon is deposited on the surface of the sample substrate 12.

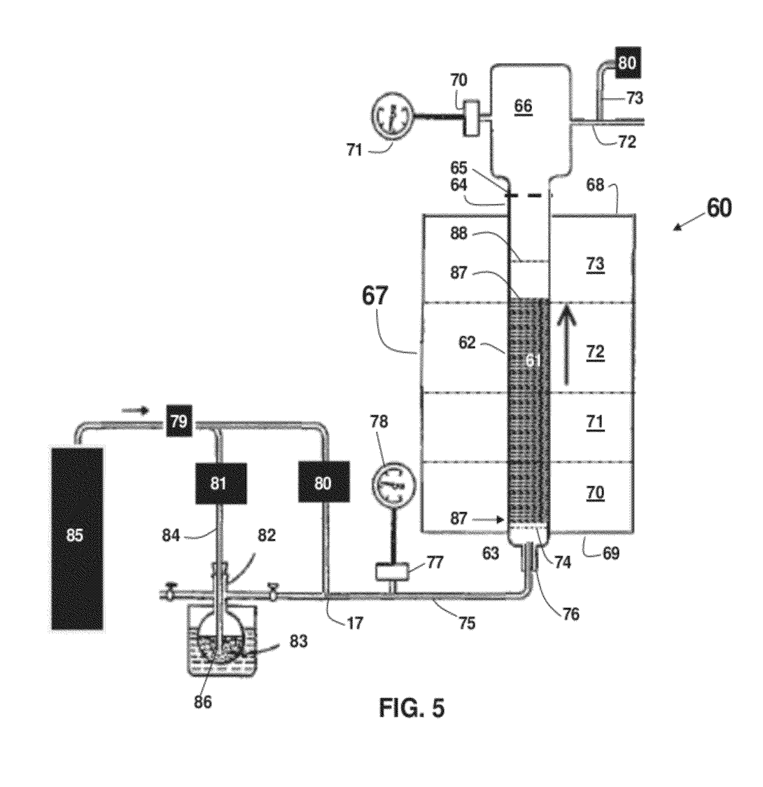

An example chemical vapor deposition apparatus utilizing a fluidized bed for economical production of large batches (>500 g) of laminated substrate is shown schematically in FIG. 5 by reference numeral 60. Substrate 61 to be laminated with carbon is placed within a vertical tubular reaction chamber 62 that has a first end 63 and a second end 64. In close proximity to the first end 63, a diffusion plate 74 is placed to allow process gas from the gas reservoir 85 to flow through but also prevent substrate 61 in the reaction chamber 62 from entering inlet gas tube 75. The diffusion plate can be a solid plate with a plurality of small holes drilled or it can be a quartz frit of high porosity. Quartz felt 87 may or may not be used to keep the particles from passing or clogging the filter. The felt also acts like a diffuser. In another embodiment, the diffusion plate is accessed for cleaning by an additional ground glass joint located between first end of reactor 63 and first end of furnace 69.

The second end 64 of reaction chamber 62 is connected to an exhaust cap 66 through a ground glass joint 65. Ground glass joint may be disposed between second end 68 of furnace 67 and second end 64 of reaction chamber 62. A pressure transducer 70 with pressure reader 71 and is also connected to exhaust port 66. The exhaust gas and reaction byproducts exit the reactor through port 72. Optionally, exhaust port 72 is connected to a gas chromatograph and a residual gas analyzer mass spectrometer 80 through a sampling tube 73 and an injection valve to monitor and control the reaction byproducts. Optionally, port 73 can be outfitted with an adsorption tube that can be occasionally desorbed into the GCMS at regular intervals.

Reaction chamber 62, which may be quartz, is situated within a furnace 67. In the illustrated embodiment, furnace 67 includes a plurality of independently controlled heating zones comprising a first heating zone 70, a second heating zone 71, a third heating zone 72, and a fourth heating zone 73. Each zone may be operated independently at selected temperatures. In some embodiments, each of the heating zones 70-73 may be controlled to a common temperature during the reaction process. The number of heating zones may be selected to provide enough heating energy to the process to thoroughly maintain a constant radial temperature profile across reaction chamber 62 at one or more desired set point temperatures. Inlet tube 75 is connected to the reaction chamber 62 with an o-ring and end fittings 76. Furnace 37 also includes means for maintaining the reaction temperature, e.g., 500-1500° C., within the reaction chamber 62 for the chemical vapor deposition of the present invention.

The pressure within tubular reaction chamber 62 is typically maintained at a reaction pressure which exceeds atmospheric pressure. The pressure within reaction chamber 62 may be measured by vacuum sensor 77 and indicated by vacuum gauge 78, or by any other suitable means. In other apparatus, it is envisioned that a flow control system may receive an input signal from vacuum sensor 77 or 71 or a combination of 71 and 77 to control the process flow by adjusting flow controllers 80 and 81 accordingly. Additionally, means of monitoring the flow of vapor into the reaction chamber may be provided.

Reaction chamber 62 is connected to tubing 75 which is in turn connected to a flask 82 containing a carbon source 83. The temperature of carbon source 83 may be maintained by a temperature control bath, such as that described above with respect to flask 36, in which flask 82 is immersed, or by other suitable means known in the art. It is preferred that the carbon source 83 and the temperature control bath are both stirred. In other embodiments, carbon source 83 need not be temperature controlled, and may be sampled at room temperature. The inert makeup gas from pressurized gas reservoir 85 can be selected from any inert gas. An example inert gas useful in the present invention is nitrogen. An oxygen scrubber 79 may be employed between pressurized gas source 85 and flow controllers 80 and 81 to remove any residual oxygen in the event that oxygen free carbon coatings are desired. However, if oxygen containing carbon coatings are desired, the amount of oxygen can be metered in with the described apparatus.

Carbon laden vapor is carried through the tubing 75 and into the reaction chamber 62, where it decomposes upon contact with sample substrate 61 maintained at an elevated temperature, e.g., 500-1500° C., within the reaction chamber. The materials in the reaction chamber 62 are mixed by the flowing gas entering the reactor through inlet 75. When the flow is zero, initial bed height 87 is defined as the distance between the distribution plate 74 and the upper extent of packed substrate 61. When the gas flow is set to the optimum flow, the bed height expands to an operating bed height that is greater than initial bed height 87. This phenomenon is called fluidization. The optimum flow to produce a fluidized bed depends on the flow rate, the cross sectional area of the reactor, the density of the particles, the viscosity of the gas, the particle diameter and shape, and the bed permeability. The flow rate is preferably set at a flow rate where entrainment is not observed. Entrainment occurs when the upward buoyancy exceeds the gravitational pull and the bed becomes unstable and the particles rise off the bed and into the headspace 66 where they either fall back to the bed or exit the reactor through the exhaust port 72.

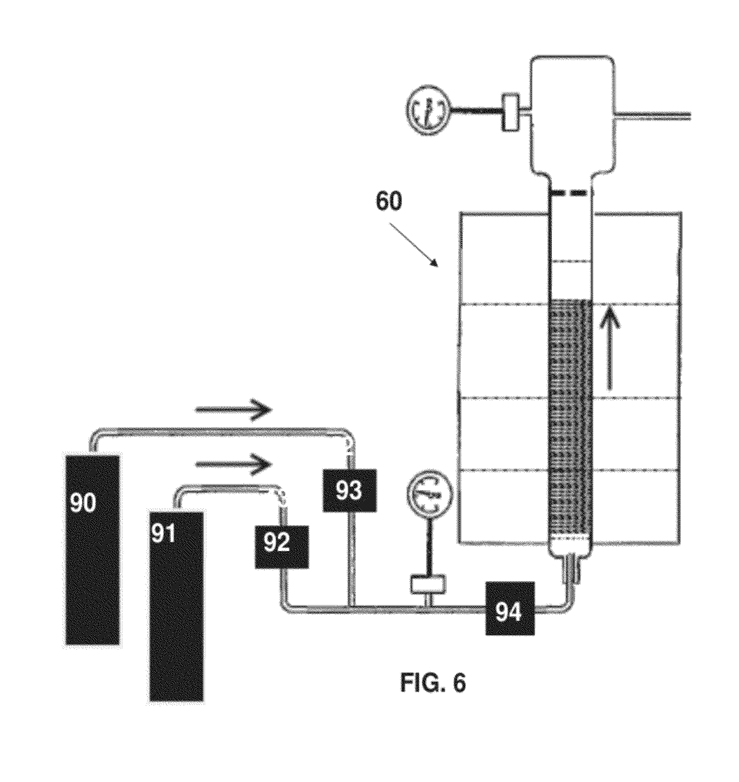

FIG. 6 is an additional embodiment similar to that disclosed in FIG. 5 except the makeup gas container 85 is replaced with two gas containers 90,91. The gas should be as oxygen free as possible so it is preferred that oxygen scrubbers 92, 93 be placed in the flowing stream. The gas container 90 can contain any gas that contains a carbon source. The gas container 91 preferably contains a makeup or secondary gas. This gas can be any inert gas or any reactive gas.

The present carbon laminated materials are useful in at least the following four applications:

First, the present carbon laminated particles can be packed or loosely placed in tubes for solid phase extraction. The tubes can be of any shape but are preferably cylindrical. Conical tubes are also widely used in the art. In one embodiment, the laminated particles may be packed in a polymeric container in which the packed bed may or may not be held in place by one or more polymeric frits or porous plugs. Unlike packing arrangements for HPLC, SPE support materials are preferably packed at low pressures that do not typically exceed 200 psi. Loose material may also be added to polymeric centrifuge tubes to accomplish a solid phase extraction. It is anticipated that the carbon laminated particles may also be impregnated into macroporous polymeric membranes.

Second, the present carbon laminated materials are useful to remove nonpolar, polar, and hydrophobic contaminants from strong HPLC solvents, such as methanol, acetonitrile, and isopropyl alcohol and water mixtures thereof. This may be accomplished by exposing a disposable cylinder or permeable disk that has been packed or impregnated with the carbon laminated materials of the present invention to the HPLC solvent stream. The cartridge may be installed at a location downstream from the pump and upstream from the column Alternatively, the cartridge may be installed upstream from the pump. However, the particles likely need to be several millimeters in diameter in such an embodiment in order to prevent unintended pre-pump flow restriction. No chromatography takes place in this application. The present materials are used as disposable sorption materials.

Third, the present carbon laminated materials may be useful to remove perfluorinated acids from water streams and strong solvents such as methanol.

Fourth, the carbon laminated particles of this invention may be used in QuEChERS, dispersive-SPE, SPE, and MSPD (matrix solid phase dispersion). For example, the carbon laminated materials are useful to remove pigments and other polar pesticides from food stuffs. For example, the carbon laminated materials can be used with the QuEChERS (Quick, Easy, Cheap, Effective, Rugged and Safe) procedure widely used in sample preparation. The technique is distinct from SPE in that only two steps are used to extract the analytes, unlike SPE, which usually requires at least four distinct solvent additions. QuEChERs is usually accomplished in a centrifuge tube and therefore does not require the particles to be packed in a bed like SPE does. This is termed “dispersive-SPE”. The steps include placing a plurality of adsorptive particles having various selectivity, carbon laminated material having selectivity for polar and nonpolar analytes, into an appropriately sized centrifuge tube. Second, the sample is added to the tube and a portion of the analyte that has affinity for the surface of the carbon adsorbs to the carbon dispersed in the tube. Although QuEChERS is an extraction procedure, it is not an extraction/concentration procedure like SPE.

The invention will be further described by reference to the following detailed Examples. The Examples are directed to the following subject matter:

### EXAMPLE 1

Chemical Vapor Deposition of Carbon on Core Alumina with Hexane as Carbon Source

In order to deposit a thin film of carbon over alumina substrate, “bare” alumina substrate was treated as follows.

25 g of porous Al2O3 which had a diameter of about 60-200 μm and a surface area of 100 m2/g and an average pore diameter of 90 angstroms was placed in a reaction chamber as illustrated in FIG. 4. Ultrapure nitrogen gas flow rate was set at 200 mL/min for both flow meters 15 and 11 and the apparatus was completely purged for 10 minutes. The furnace was then heated to a temperature of 700° C. After equilibrating at 700° C. for about 10 minutes, the flow controller to the flask containing HPLC grade hexanes at 0° C. was set at 200 mL/min, allowing hexane vapor to enter the reaction chamber. The carbon source was thermostatted at room temperature. During the first hour, the particles gain approximately 10% carbon. After 6 hrs, the particles are 20% carbon. By visual observation, the particles were free-flowing and undamaged by the CVD treatment. The specific surface area and average pore diameter of the coated substrate particles were measured and found to be 89 m²/g and 60 angstroms, respectively. The particles did not break when ground with a mortar and pestle.

### EXAMPLE 2

Effect of Varying Deposition Time at 700° C.

This example describes an experiment designed to determine the effect of deposition time on amount of carbon deposited and surface area under constant deposition conditions. Four tests were completed in which samples of alumina underwent CVD of carbon for 1, 3, 6, and 12 hours, respectively. Each of the four samples consisted of 2 g of porous SPE grade alumina, obtained from MP Biosciences, having a particle size of about 150 micron and a surface area of 150 m²/g. The percent carbon from each run was 9, 22, 24, 26%

These results show that at a constant deposition temperature and pressure, the weight percent of the carbon coating increases with increasing deposition time.

### EXAMPLE 3

Use of Methylene Chloride as Carbon Source

This example describes the use of methylene chloride, rather than hexanes, as the carbon source for the CVD process. A 25 g sample of SiO2 SPE particles were obtained from Sigma Aldrich which had a diameter of about 100 microns, a surface area of 100 m²/g, and an average pore diameter of about 90 angstroms were placed in the apparatus shown in FIG. 4. The procedure used in the first example was used except the methylene chloride was thermostatted in a dry ice acetone batch. Percent carbon was 12%.

The amount of-carbon source vaporized during each test was determined by weighing each flask at the beginning and the end of each test.

### EXAMPLE 4

Masking of Uncovered Residual Alumina Sites with Phosphoric Acid

25 grams of carbon laminated alumina was placed in 1 N phosphoric acid and heated at 80° C. while stirring for 4 hours. Recovery of pirmicarb and bromacil improved significantly.

### EXAMPLE 5

Determination of Exposed Alumina and Silica

The technique used to determine the carbon coverage of the alumina particles involved observation of the breakthrough of a UV-active benzoic acid or organophosphate compound such as phenyl phosphate through a chromatographic column

### EXAMPLE 6

Batch-to-Batch Characteristics

TABLE 1
Batch to batch Comparison of percent carbon and recovery for
materials manufactured under the protocol of Example 1.

| | Number | | Bromacil |
|---|---|---|---|
| Material Type | of Batches | % Carbon | Recovery % |
| Carbon | 5 | 20 +/− 0.5 | 96 +/− 4 |
| Laminated | | | |
| Alumina | | | |
| Carbon | 5 | 12 +/− 0.5 | 97 +/− 4 |
| Laminated | | | |
| Silica | | | |

### EXAMPLE 7

Determination of Breakthrough Volume of Carbon Laminated Alumina and Silica

Solutions of bromacil (50 μg/mL) were added sequentially and the eluent was monitored with a UV spectrometer for a “3 mL” SPE cartridge and a “6 mL” SPE cartridge. The volume of SPE support material placed in the 3 and 6 mL cartridges were the same for both the carbon on alumina and the carbon on silica. The mass was different because of the density differences between silica and alumina. We compared the loadability with SampliQ, a commercially available carbon SPE support material.

TABLE 2
A Comparison of the Breakthrough of Bromacil
On Carbon Laminated Alumina and Silica.

| | | Bromacil | | |
|---|---|---|---|---|
| | | Breakthrough | | |
| Material | Cartridge | Mass (mg) | % Carbon | Mass (g) |
| COA | 3 | 4.5 | 20 | 0.9 |
| COS | 3 | 0.45 | 5 | 0.4 |
| SampliQ | 3 | 5 | 100 | |
| COA | 6 | 10 | 20 | 1.8 |
| COS | 6 | 0.9 | 5 | 0.8 |
| SampliQ | 6 | 10 | 100 | |

### EXAMPLE 8

Determination of the Recovery of Bromacil and Pirimicarb on Carbon Laminated Alumina and Silica

The SPE extraction and concentration protocol was as follows:
Packing: Cartridges packed with 0.7 g of Carbon on Alumina obtained through the method of the present invention
SPE Condition: 5 mL 4:1 CH2Cl2:ACN, then 2 mL ACN, then 10 mL 2% acetic acid in H2O.
Sample Application: Apply 1 mL Bromacil (in 10% MeOH in H2O). Pirimicarb (1 mL) added either during this step of after elution step.
Wash/Dry: No change
Elution: Pass 2 mL ACN, then 2-2 mL of 4:1 CH2Cl2.:ACN. Collect all eluent in same vessel. Evaporate to dryness and reconstitute with 80/20 H20/ACN.

The reconstituted sample was injected onto an HPLC column with the following conditions:
Column-Zorbax Eclipse XDB-C-18 4.6×50 mm, 5 μm
Mobile Phase A: 10/90 ACN/H2O with 0.1% Formic Acid
Mobile Phase B: 90/10 ACN/H2O with 0.1% Formic Acid
25 μl injection
Detector: 290 nm
Column temp: 35° C.
The gradient conditions are as follows: Time=0 min, 5% B; 5 min, 80% B; 6 min, 5% B.

The results are as follows:

TABLE 3
Recovery of bromacil and pirmicarb on 0.7 g of carbon laminated alumina.

| | | Pirimicarb | | Bromacil | | Bromacil |
|---|---|---|---|---|---|---|
| | | Ave | % RSD | Ave | % RSD | Relative |
| | | Absolute | within | Absolute | within | Recovery |
| % Carbon | Cartridge | Recovery | cartridge | Recovery | cartridge | (%) |
| 18 | 1 | 78.2 | 10.2 | 97.9 | 1.8 | 125% |
| 18 | 2 | 83.0 | 6.0 | 99.8 | 1.1 | 120% |
| 18 | 3 | 78.8 | 7.3 | 97.3 | 1.0 | 123% |
| 20 | 1 | 82.0 | 9.2 | 96.1 | 1.1 | 113% |
| 20 | 2 | 87.8 | 2.8 | 92.2 | 1.7 | 105% |
| 20 | 3 | 89.5 | 2.0 | 95.6 | 1.4 | 107% |

Cartridge-to-cartridge

| | | | |
|---|---|---|---|
| AVE | STDEV | AVE | STDEV |
| 83.2 | 4.6 | 96.5 | 2.6 |

Bromacil and pirmicarb concentrations are 50 μg/mL.

TABLE 4
Recovery of bromacil and pirmicarb on
0.4 g of carbon laminated silica.

| | |
|---|---|
| Pirmicarb | Bromacil |

| | | Average | % | Average | % |
|---|---|---|---|---|---|
| Batch | Cartridge | recovery | RSD | recovery | RSD |
| 1 | 1 | 98 | 1 | 97 | 1 |
| 1 | 2 | 95 | 2 | 98 | 1 |
| 1 | 3 | 93 | 2 | 96 | 1 |
| 1 | 4 | 95 | 1 | 97 | 1 |
| 1 | 5 | 95 | 1 | 97 | 1 |
| 2 | 1 | 91 | 1 | 90 | 1 |
| 2 | 2 | 96 | 2 | 94 | 1 |
| 2 | 3 | 97 | 2 | 96 | 1 |
| 2 | 4 | 98 | 3 | 98 | 0 |
| 2 | 5 | 96 | 2 | 101 | 1 |
| 3 | 1 | 104 | 1 | 102 | 1 |
| 3 | 2 | 100 | 0 | 100 | 1 |
| 3 | 3 | 98 | 1 | 99 | 1 |
| 3 | 4 | 99 | 1 | 100 | 1 |
| 3 | 5 | 93 | 1 | 97 | 1 |
| 4 | 1 | 92 | 2 | 99 | 1 |
| 4 | 2 | 92 | 1 | 102 | 1 |
| 4 | 3 | 90 | 1 | 100 | 1 |
| 4 | 4 | 91 | 1 | 102 | 1 |
| 4 | 5 | 91 | 0 | 101 | 1 |

### EXAMPLE 9

Determination of the Linearity of Recovery on Carbon Laminated Alumina and Silica

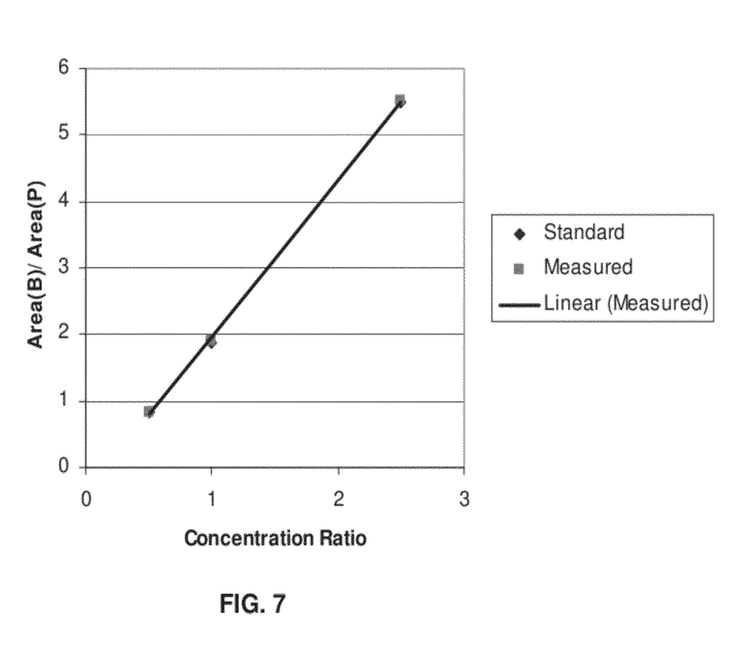

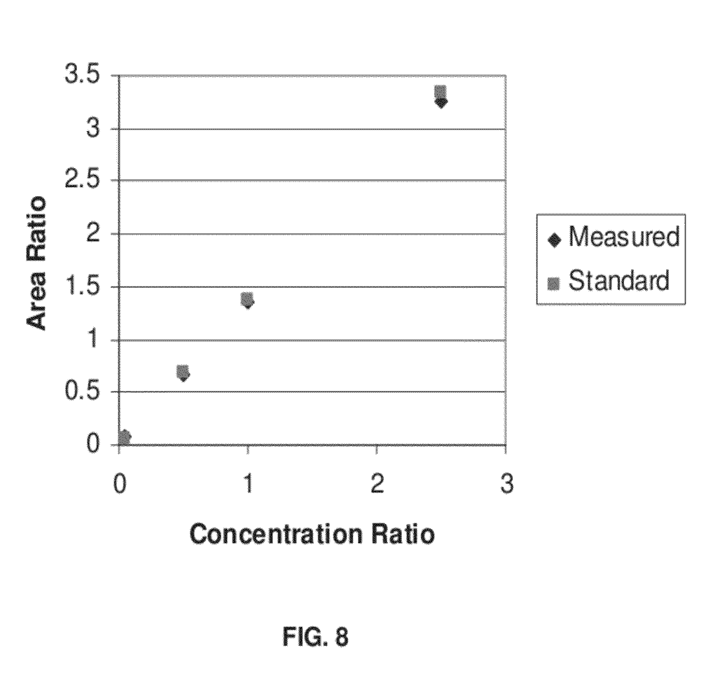

FIG. 7 and FIG. 8 show the linearity of recovery as a function of bromacil concentration on both carbon laminated alumina and silica SPE materials respectively.

### EXAMPLE 10

Flow Test

The flow test measures the time to flow 10 mL of methylene chloride through the cartridge. This test has compared the commercially available prior art to carbon laminated alumina.

TABLE 5
Flow test comparison.

| | |
|---|---|
| COA | SampliQ |

| | Ave | | Ave | |
|---|---|---|---|---|
| Cartridge | Time(min) | % RSD | Time(min) | % RSD |
| 1 | 2:30 | 2% | 10:03 | 4% |
| 2 | 2:28 | 2% | 8:18 | 4% |
| 3 | 2:37 | 1% | 4:46 | 1% |
| 4 | 2:44 | | | |
| 5 | 2:50 | | | |

1. N = 3 for each cartridge

### EXAMPLE 11

Recovery of PFOA

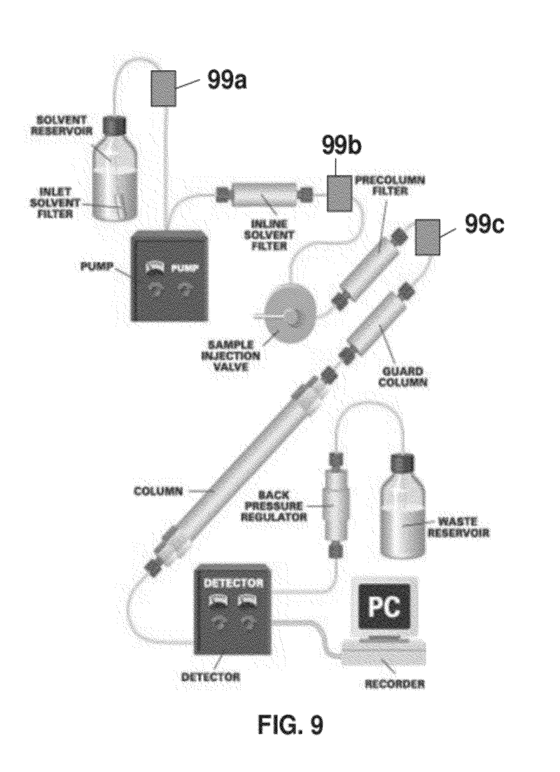

We replaced hexane carbon source with acetonitrile to incorporate nitrogen into the carbon. Using the procedure outlined in Example 2, we deposited 10% carbon and 3% nitrogen on the alumina. We have shown that 95% of persistent and toxic organic pollutant, perfluorooctanoic acid (PFOA) spiked drinking water can be quantitatively sorbed and then subsequently recovered from this material using trifluoroacetic acid in methylene chloride. Most importantly, we found that it can remove PFOA from strong solvents such as methanol and acetonitrile. FIG. 9 shows an application for removal of PFOA from a high pressure liquid chromatography system. The carbon laminated particles may be packed in a small column and installed in a HPLC system downstream from the pump and upstream from the injector 99b. This eluent clean up cartridge and installation location has the advantages that it does not add any pre-pump flow restriction as in 99a, and does not add dead volume as in 99c. In addition, the eluent cleanup cartridge may be installed on the high pressure side of the pump. Such an installation location is possible because the particles are mechanically stable. However, it is to be understood that any installation location in the fluidic path including 99a, 99b, and 99c may be appropriate.

### EXAMPLE 12

QuEChERs

We optimized the materials described above for the QuEChERs technique as is widely practiced and as is well known in the art. In this case, 50 mg of carbon black is used to remove color from spinach (or other vegetable) extracts. We replaced carbon black with 50 mg of carbon laminated alumina and showed equal performance. The carbon laminated alumina particle in this case is preferably 5-300 μm in diameter and has pore diameters that are greater than 10 angstroms with a carbon coating that is 3-30% of the composite, as measured by elemental analysis. In a particular embodiment, the carbon coated flash chromatography-grade alumina (30-60 μm in diameter) was coated with 8-10% carbon and had a 90 angstrom pore size.

### EXAMPLE 13

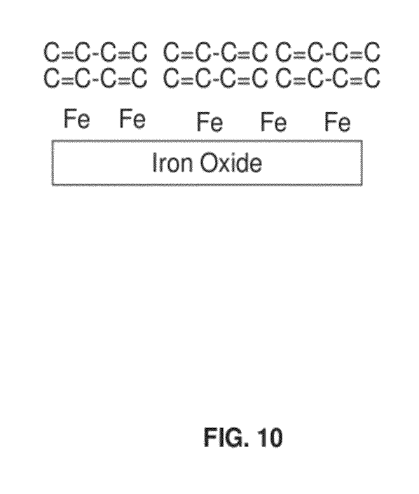

FIG. 10 shows an additional embodiment for the particle of present invention showing carbon coating on iron particles. The particle is comprised of an iron core that is either porous or non porous. The iron can be coated onto a porous substrate. The porous substrate can be an alumina or a silica. In addition, porous iron particles can be made from colloidal suspensions or spray dried. The iron particles can also be non porous and are readily available from many commercial sources. These materials include porous and nonporous rods, whiskers, membranes, fabrics, wools, or macroporous frits. The particle can be spherical or irregularly shaped and have diameters ranging from a few nano meters to several mm in diameter. The carbon is readily placed on the surface of the iron following the methods and using the apparatus described above. Varying amounts of carbon can be placed on the surface as the application demands. In similar fashion, the uncovered iron can be masked with an appropriate reagent as the method requires. This may require a hydrophobic masking reagent or charged reagent.

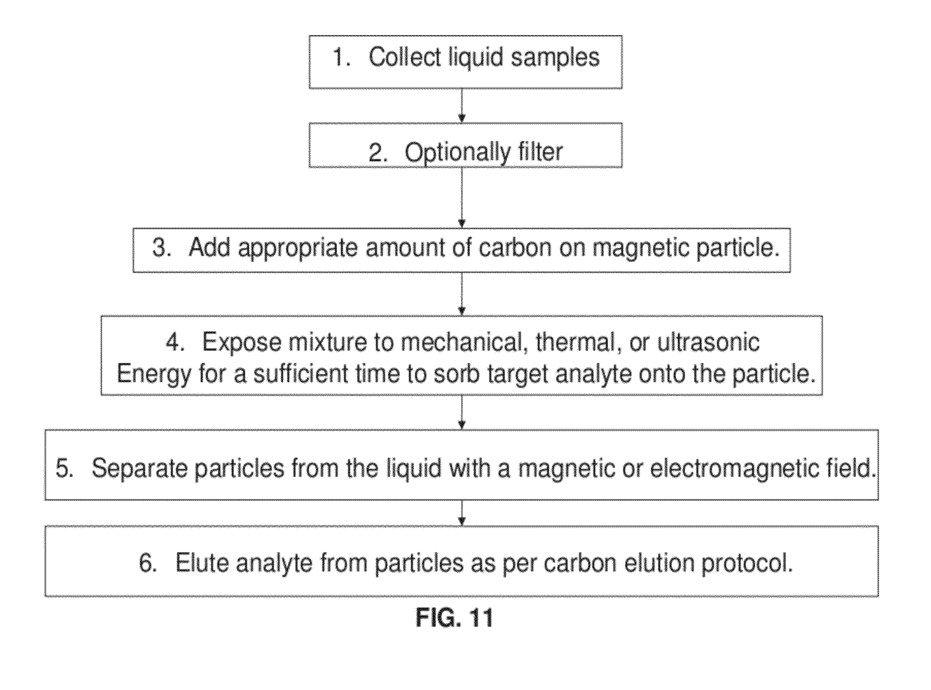

Carbon laminated iron particles may be useful for selective sorption with magnetic separation. In one application, trace pesticides, PAHs, mycotoxins, or any other polar molecule with an affinity for carbon can be concentrated and removed from large amounts of water. FIG. 11 depicts a possible method for carbon on iron particles in pesticides analysis. In a laboratory method, the samples are usually collected and filtered into 1 L containers. An appropriate amount of carbon laminated iron is placed into the 1 L container and mixed. Mixing can be ultrasonic, vortex, or any other appropriate mechanical shaking or stirring method. The carbon particles adsorb the analyte of interest and then are removed from the container with a magnet. Alternatively, they can be sequestered by a magnet inside the vessel and the liquid supernatant can be removed. The analytes can then be eluted from the particles by any number of techniques that is commonly described in the art.

There exists an urgent need for remediation and oil separation technologies that separate tar balls or bitumen from seawater, freshwater, and sand. There is also a longer term need for technologies for remediation of stockpiled contaminated sand from beaches, wildlife refuges, and other waterways that move beyond passive sorbents currently in use. This need extends to more than just oil sorption. Polycyclic aromatic hydrocarbons (PAHs) are present in large quantities in crude oil. As a pollutant, they are of concern because some compounds are carcinogenic, mutagenic, and teratogenic and can enter the food supply easily through various means. PAHs tend to concentrate in cereals, oils and fats. Environmentally benign carbon coated magnetic iron may be useful as a PAH and oil remediation sorbent media. This media will not have the same toxic impact as alternative sorbents or remediation media because it can easily be recovered from sand. If it spills, iron oxide and carbon is not considered toxic. Furthermore, an oil laden particle can be easily remediated by incineration in a kiln to produce CO2 and iron oxide.

Carbon coated on iron oxide may also be used to sorb excessive oil from a brine solution. The oil laden carbon-iron oxide particles can be easily separated from solution using a magnet. It is already well known in the literature that PAHs have a strong affinity for carbon. Carbon laminated iron oxide particles can be very useful for remediation and environmental triage for a variety of applications. The method of the present invention is capable of producing carbon coated iron oxide in batches of, for example. 20 g in 6 hours. Such a procedure may be scaled up to produce, for example, 480 kg/day using a fluidized bed to deposit carbon. Such reactors incorporate a continuous input auger so that uncoated material is automatically fed into the reactor and automatically gathered as the reaction is completes.

### EXAMPLE 14

Effect of Carbon Source Temperature on Carbon Deposition Rate

This example describes the effect of carbon source temperature on reaction time. The procedure was repeated with the carbon source thermostatted at 0° C. The resulting particles showed a percent carbon of 3% after 6 hours.

### EXAMPLE 15

This example describes the effect of reactor pressure on the reaction time. The procedure in Example 1 was repeated at 50 mm Hg. The resulting particles showed a percent carbon of 2% after 6 hours reaction time.

### EXAMPLE 16

Scale Up to an Economically Viable Production Process

This example describes the scale up of solid phase extraction particles in a 5 in diameter×4 ft length cylindrical fluidized bed. The reactor incorporated a frit as described above. 5 kg of flash grade silica (30-60 μm) particles were added to a fluidized bed reactor as described in FIG. 5. The carbon source was hexane and the makeup gas was nitrogen (99% pure). The nitrogen flow rate was set at 6.7 liters/minute to achieve fluidization of the reactor bed. To maintain fluidization, it was necessary to increase the flow rate over time. Fluidization was monitored visually and with a pressure gauge. The carbon source was thermostatted at room temperature. At 6 hours subsequent to the initiation of the reaction, the composite particles were measured under elemental analysis at 7% carbon. At 12 hours reaction time, the particles were 15% carbon. The particles were cooled to room temperature under pure nitrogen conditions. The particles were subsequently treated according to procedures described in previous examples.

What is claimed is:

1. A material for sample preparation comprising: carbon deposited on a particulate substrate of a plurality of particles, with said particles having a minimum particle cross-sectional dimension of between 20-700 μm.

2. The material of claim 1 wherein said particles are porous.

3. The material of claim 2, having a surface area of at least 50 m²/g.

4. The material of claim 2 that is molded to form a porous frit.

5. The material of claim 2 having a minimum pore diameter of 60 angstroms

6. The material of claim 1, wherein said particulate substrate is selected from the group consisting of alumina, silica, silicon carbide, silicon nitride, titanium carbide, titanium nitride, zirconia, ceria, glass, metal or ceramic whiskers, and combinations thereof.

7. A solid phase extraction media as in claim 45 wherein said substrate is silica, and said second region is
substantially free from silanol groups.

8. A solid phase extraction media as in claim 7 wherein said composite includes 3-40% carbon, as measured by elemental analysis.

9. A solid phase extraction media as in claim 45 wherein said substrate is alumina, and said second region is
being substantially free from available Lewis acid sites.

10. (canceled)

11. A method as in claim 41 wherein said reaction conditions establish a fluidized bed of said substrate in said reaction chamber.

12-31. (canceled)

32. A sample preparation method utilizing the composite sample preparation material of claim 1, wherein the method is solid phase extraction, QuECHers, dispersive solid phase extraction, flash chromatography, supercritical fluid extraction, or preparative chromatography.

33-37. (canceled)

38. A method as in claim 41 wherein said reactor is operated as one of a fluidized bed, entrained flow, horizontal rotary kiln, or a packed bed reactor.

39-40. (canceled)

41. A method of producing a composite sample preparation material including carbon deposited on a substrate, said method comprising:
(a) providing a reactor having a chamber;
(b) providing a carbon source in a source vessel that is separate from, but fluidly coupled to said reactor chamber;
(c) placing said substrate in said reactor chamber;
(d) supplying carbon from said source vessel to said reactor chamber;
(e) operating said reactor for a reaction time at reaction conditions suitable to cause carbon to deposit onto said substrate, with said reaction conditions including a pressure within said reactor chamber of at least environmental atmospheric pressure.

42. A method as in claim 41 wherein said environmental atmospheric pressure is 760 mm Hg.

43. A method as in claim 41 wherein said reaction conditions include a temperature within said reactor chamber of between 500-2500° C.

44. A method as in claim 41 wherein said reaction conditions establish a fluidized bed of said substrate in said reactor chamber.

45. A solid phase extraction media, comprising:
A composite of carbon deposited on a substrate to form a non-uniform carbon coating with a first carbon-coated region and a second region, wherein said second region of said substrate exhibits a modified chemical activity.

46. A solid phase extraction media as in claim 45 wherein said second region is not coated by said deposited carbon.

47. A method as in claim 41 wherein said carbon source is substantially oxygen-free.

48. A method as in claim 41 wherein said reaction conditions are suitable to cause carbon to deposit onto said substrate at a rate to form said composite sample preparation material with at least one percent carbon, as determined by elemental analysis, within said reaction time, wherein said reaction time is six hours.

49. A method as in claim 41 wherein said carbon source is maintained at a temperature between 20-35° C.

50. A material for sample preparation, comprising;
Carbon deposited on a particulate substrate of a plurality of particles, with said particles having a maximum particle cross-sectional dimension of between 1-1000 nanometers.

51. A material as in claim 50 wherein said particles are non-porous.
